(19) United States
(12) Patent Application Publication
(10) Pub. No.: US 2012/0266203 A1
(43) Pub. Date: Oct. 18, 2012

(54) INGEST-ONCE WRITE-MANY BROADCAST VIDEO PRODUCTION SYSTEM

(75) Inventors: Michael Elhadad, Beer Sheva (IL); Moisei Rabinovich, Beer Sheva (IL)

(73) Assignee: Dalet, S.A., Levallois-Perret (FR)

(21) Appl. No.: 13/085,507

(22) Filed: Apr. 13, 2011

(51) Int. Cl. H04N 7/173

(52) U.S. Cl. 725/115; 725/116

(57) ABSTRACT

A video ingest system, including a video server, including a receiver for receiving incoming video feeds, a video encoder for encoding incoming video feeds on-the-fly to one or more versions of high resolution video sample data, and to one or more versions of low resolution video sample data, and a transmitter for transmitting versions of the low resolution video sample data to respective ones of a plurality of storage units, and for transmitting high resolution video sample data to a broadcaster, a plurality of storage units, coupled communicatively with the video server, and a plurality of workstations, coupled communicatively with respective ones of the plurality of storage units, each workstation including a receiver for receiving a version of the low resolution video sample data from a storage unit, a video previewer for rendering the version of the low resolution video sample data, and a proxy video editor for generating edit instructions for the low resolution video sample data that is rendered by said video previewer.

### FIELD OF THE INVENTION

The present invention relates to production of video for broadcast.

### BACKGROUND OF THE INVENTION

Conventional video servers are used for providing digital video content. For efficiency of workflow, video servers are required to accommodate (i) editing and previewing of the video by a large number of concurrent users, (ii) as soon as possible, and (iii) in a reliable manner. To satisfy requirement (i), high disk bandwidth and high network bandwidth are required. To satisfy requirement (ii), low latency is required. To satisfy requirement (iii), multiple copies of video material are stored on multiple storage devices.

Reference is made to FIG. 1, which is a flowchart of a prior art workflow 1000 for ingesting video by a video server. The flowchart of FIG. 1 is divided into three columns. The leftmost column includes operations performed by a video server, the middle column includes operations performed by each of multiple conversion agents, and the rightmost column includes operations performed by each of multiple previewing and editing clients. At operation 1010 the video server encodes an incoming analog or serial digital interface (SDI) video signal. Generally, the incoming video is encoded into a high resolution format. At operation 1020 the video server writes the encoded video to a dedicated storage.

After completion of step 1020, each conversion agent may begin its task. At operation 1030 the conversion agent reads the encoded video from the dedicated storage. At operation 1040 the conversion agent decodes the encoded video. At operation 1050 the conversion agent re-encodes the decoded video into a target format. At operation 1060 the conversion agent writes the re-encoded video to a target storage device. The multiple target formats generated by the multiple conversion agents generally include highly compressed formats for streaming and proxy editing. Such highly compressed formats reduce the storage and network bandwidth loads required to perform previewing and editing of video content.

After a conversion agent completes operations 1030-1060 and writes its video to a target device, a previewing and editing client may read the video from the target device and perform its tasks. At operation 1070 the previewing and editing client reads the re-encoded video from a target storage device. At operation 1080 the previewing and editing client applies interactive previewing and editing processes for user video production.

It will be appreciated that the prior art workflow entails many read operations from the dedicated storage, and the computational burden of decoding the high resolution format stored on the dedicated storage. The prior art workflow also entails latency of waiting until the encoded high resolution version has been flushed to disk, then read, then decoded, then encoded into a target format, and then flushed to disk again, before previewing and editing is enabled. I.e., with reference to FIG. 1, a previewing and editing client may only perform operations 1070 and 1080 after the video server and a conversion agent have completed operations 1010-1060. The flushing to disk of the high resolution version at operation 1020 is a particularly slow operation over network storage, and often takes several tens of seconds to complete. In turn, the processing and bandwidth required to overcome this latency impact the hardware requirements and costs of conventional video servers.

It would thus be of advantage to provide an economical system with reduced latency for video ingest.

### SUMMARY OF THE DESCRIPTION

Aspects of the present invention relate to “ingest-once write-many” video production systems and methods. A video server generates multiple versions of video sample data, as an incoming video feed is being received. The multiple versions are stored on multiple target storage units, for low resolution proxy editing and high resolution production editing. As such, processing is off-loaded from the conversion agents to the video server, and multiple reads of high resolution video data are avoided.

Generally, the multiple versions include a high resolution version for production, a low resolution version for proxy editing, and a low resolution version for streaming. The proxy version is transmitted to a workstation, which previews the proxy version and generates edit instructions. In turn, the edit instructions are applied to the production version, and the edited production version is used by the video server as a broadcast source.

Embodiments of the present invention are of advantage in reducing storage bandwidth requirements, reducing number of servers required, saving time on media operations, and simplifying the required architecture. In addition, embodiments of the present invention provide improved disaster recovery, which is less costly and better synchronized than conventional disaster recovery systems.

There is thus provided in accordance with an embodiment of the present invention a video ingest system, including a video server, including a receiver for receiving incoming video feeds, a video encoder for encoding incoming video feeds on-the-fly to one or more versions of high resolution video sample data, and to one or more versions of low resolution video sample data, and a transmitter for transmitting versions of the low resolution video sample data to respective ones of a plurality of storage units, and for transmitting high resolution video sample data to a broadcaster, a plurality of storage units, coupled communicatively with the video server, and a plurality of workstations, coupled communicatively with respective ones of the plurality of storage units, each workstation including a receiver for receiving a version of the low resolution video sample data from a storage unit, a video previewer for rendering the version of the low resolution video sample data, and a proxy video editor for generating edit instructions for the low resolution video sample data that is rendered by said video previewer.

There is additionally provided in accordance with an embodiment of the present invention a for video ingest, including receiving, by a video server, an incoming video feed, encoding, by the video server, the incoming video feed on-the-fly to one or more versions of high resolution video sample data and to one or more versions of low resolution video sample data, transmitting, by the video server, the versions of the low resolution video sample data to respective ones of a plurality of storage units, as the encoding is being performed, and further transmitting, by the video server, high resolution video sample data to a broadcaster.

### BRIEF DESCRIPTION OF THE DRAWINGS

The present invention will be more fully understood and appreciated from the following detailed description, taken in conjunction with the drawings in which:

FIG. 1 is a flowchart of a prior art workflow for ingesting video by a video server;

FIG. 2 is a simplified flow diagram of an “ingest-once write-many” workflow for a video server, in accordance with an embodiment of the present invention;

FIG. 3 is a simplified block diagram of an “ingest-once write-many” video system, in accordance with an embodiment of the present invention;

FIGS. 4A and 4B are screen shots showing a user interface for configuring a format set for video ingest, in accordance with an embodiment of the present invention;

FIG. 5 is a simplified flow chart for an “ingest-once write-many” workflow for a media broadcast system, in accordance with an embodiment of the present invention; and

FIG. 6 is a simplified flow chart for a recovery method for ingest of a format set, in accordance with an embodiment of the present invention.

### DETAILED DESCRIPTION

Aspects of the present invention relate to an “ingest-once write-many” production system for broadcast video. In accordance with an embodiment of the present invention, ingested video is migrated from a video server, in multiple versions, to multiple target storage devices. The versions generally include a high resolution version for production, a high resolution version for backup, a low resolution version for proxy editing, and a low resolution version for streaming. Migration from the video server in multiple versions off-loads intensive processing and redundant reading of video data by conversion agents.

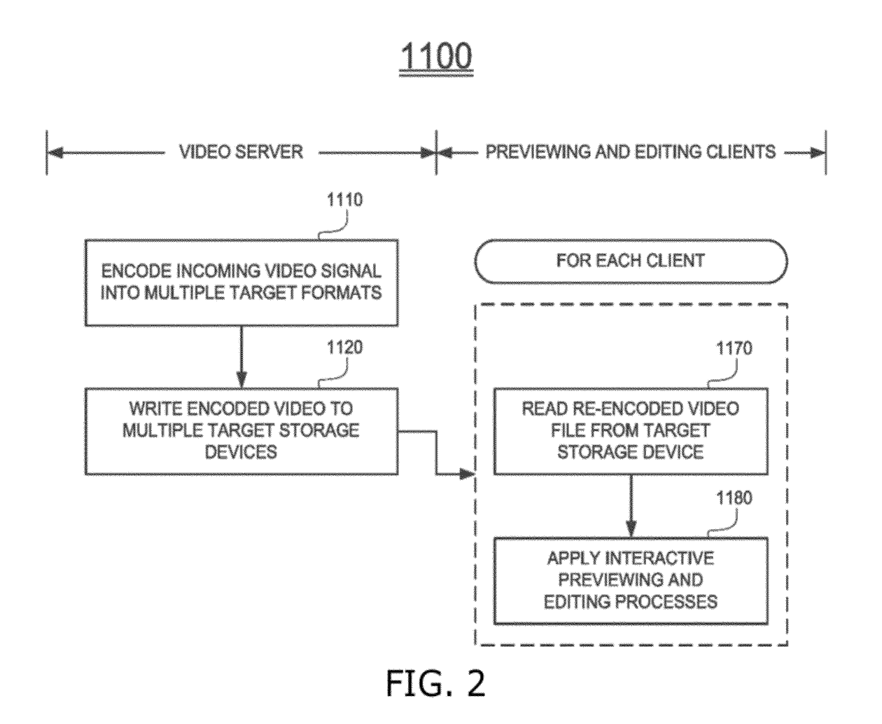

Reference is made to FIG. 2, which is a simplified flow diagram of an “ingest-once write-many” workflow 1100 for a video server, in accordance with an embodiment of the present invention. The flowchart of FIG. 2 is divided into two columns. The left column indicates operations performed by a video server, and the right column indicates operations performed by each of multiple previewing and editing clients. At operation 1110 the video server encodes an incoming analog or SDI video signal directly into multiple formats, including at least a high resolution format, a highly compressed format for streaming, and a highly compressed format for proxy editing. At step 1120 the video server writes the encoded video to multiple storage devices. Each format may be written to several devices.

After the video server writes encoded video to a target storage device, a previewing and editing client may read from the target storage device to perform its tasks. At operation 1170 the previewing and editing client reads the re-encoded video from the target storage device. At operation 1180 the previewing and editing client applies interactive previewing and editing processes for user video production.

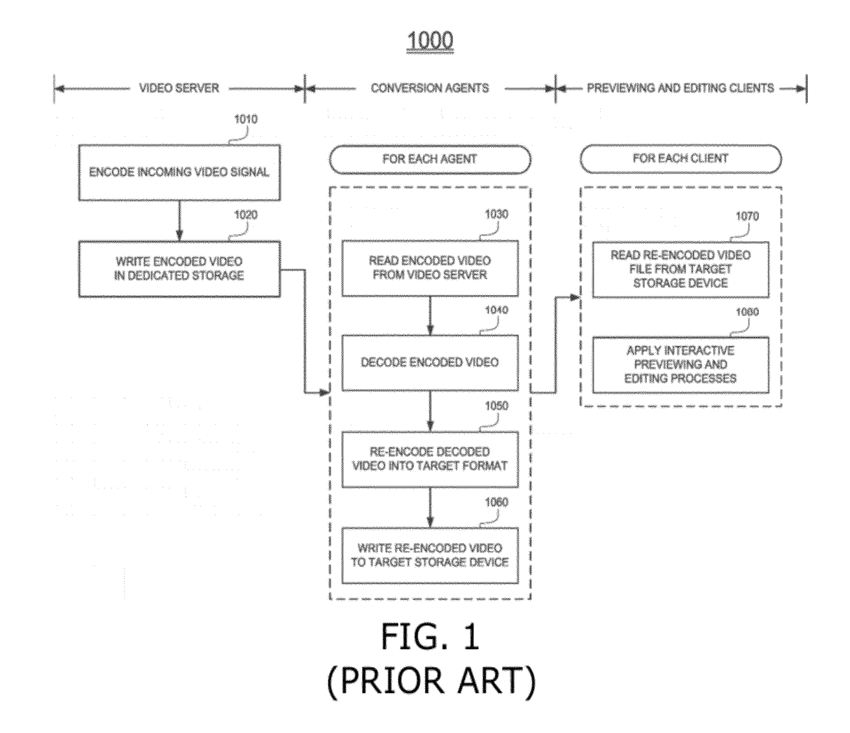

It will be appreciated that the workflow of FIG. 2 eliminates the work of the multiple conversion agents of FIG. 1 and, as such, has many advantages over the prior art workflow of FIG. 1. For each written version of video material, the workflow of FIG. 2 eliminates a read operation from dedicated storage. In turn, this eliminates the corresponding disk and network bandwidth. The workflow of FIG. 2 eliminates the burden of decoding the high resolution format, since the various target formats do not require decoding and re-encoding. The workflow of FIG. 2 directly encodes each target format and flushes it to disk, thereby reducing the latency for the target formats to become available to the previewing and editing clients. Most significantly, availability of the target formats does not depend on completion of flushing the high resolution version to disk, thereby eliminating the longest bottleneck in the prior art workflow.

Aspects of the present invention employ data structures, referred to herein as “storage units”, which encapsulate parameters that define a storage location, including inter alia:
the protocol used to read and write data;
location within the storage device as seen from different clients;
quality of service parameters, including maximum allowed read and write rates;
method used to determine whether a file is locked on the storage unit; and
method used to determine what the last committed data block on storage is for a file, while the file is being written.
   Regarding location within the storage device, it is noted that the same location may be accessed through different aliases, to improve performance on a storage network.

Aspects of the present invention further employ “local storage units (LSUs)”, which are accessible in read-mode by a large number of editing applications through industry standard protocols, and remote storage units (RSUs)”, which are only accessible by specialized software agents via a custom protocol.

In accordance with an embodiment of the present invention, the ingest-once write-many workflow is capable of writing encoded video to RSUs, via modular protocol adapter plugin components capable of writing on specific RSUs; and is capable of writing encoded video to LSUs, via modular software encoder plugins, to encode target video in multiple formats.

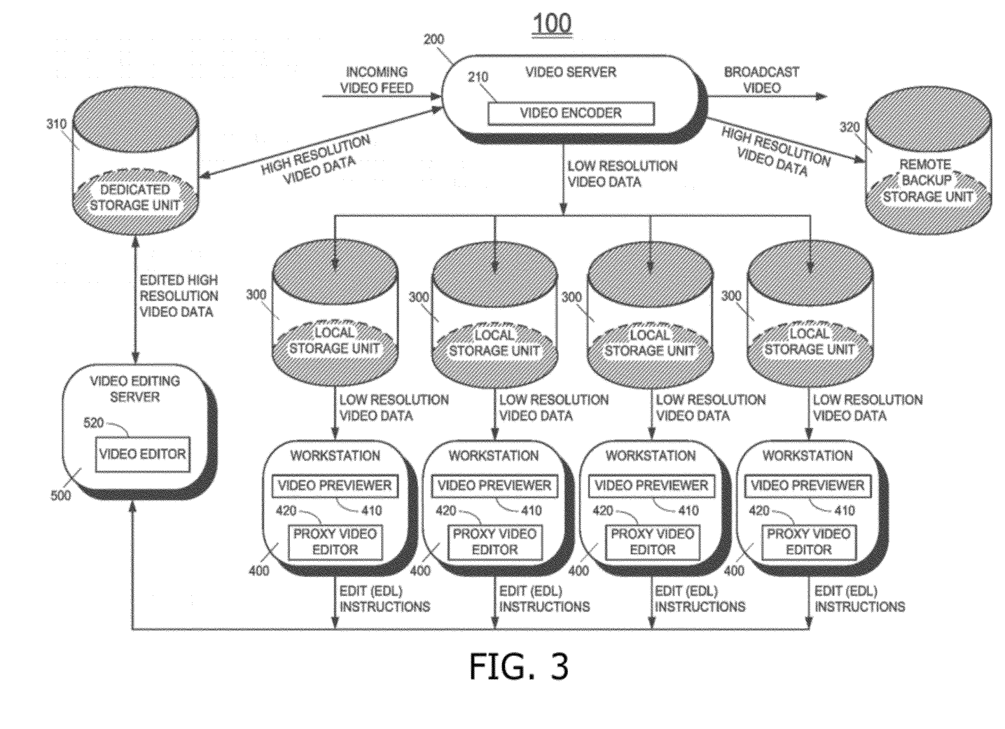

Reference is made to FIG. 3, which is a simplified block diagram of an “ingest-once write-many” video system 100, in accordance with an embodiment of the present invention. Shown in FIG. 3 are six primary components; namely, a video server 200, a plurality of local storage units (LSUs) 300, a dedicated storage unit 310, a remote backup storage unit 320, a plurality of workstations 400, and a video editing server 500. Video server 200 receives incoming video feeds, and transmits video to a broadcast source, generally for broadcast to television. LSUs 300 store low resolution versions of video. Workstations 400 provide an interface for producers to preview the videos stored on LSUs 300, and to generate edit instructions to be applied by video editing server 500 to high resolution videos.

System 100 is an “ingest-once write-many” system. Video server 200 includes a video encoder 210, which encodes incoming video feeds on-the-fly into high and low resolution video sample data, for transmission to LSUs 300, dedicated storage unit 310 and remote backup storage unit 320. Video encoder 210 supports many video formats. Some of the video formats supported are listed in TABLE I. It will be appreciated from TABLE I that generally at least three different versions of video sample data are encoded by video encoder 210; namely, (i) a high resolution version for production, stored on dedicated storage unit 310, (ii) a low resolution proxy version for editing, and (iii) a low resolution version for streaming. The high resolution version for production is generally in a format in which source material is ingested, and in which material is sent to playout. The low resolution proxy version is used for previewing and editing purposes. It is usually generated from a high resolution format. The proxy version is generally an easy-to-edit format, such as I-frames with non-interlaced audio tracks, and low bit-rate, such as small image size with high audio and video compression. The low resolution version for streaming is usually a very low resolution format for browsing, and includes portions of the video that are expected to be browsed by many users. It is usually generated from a high resolution format. The streaming version is generally a format with long MPEG groups of pictures (GOPs), very low bit-rate and high optimized compression, such as a two-pass Windows Media Video (WMV). The streaming version is usually streamed using a streaming server with Mufti-Media Messaging Service (MMS) protocol or Real-Time Streaming Protocol (RTSP).

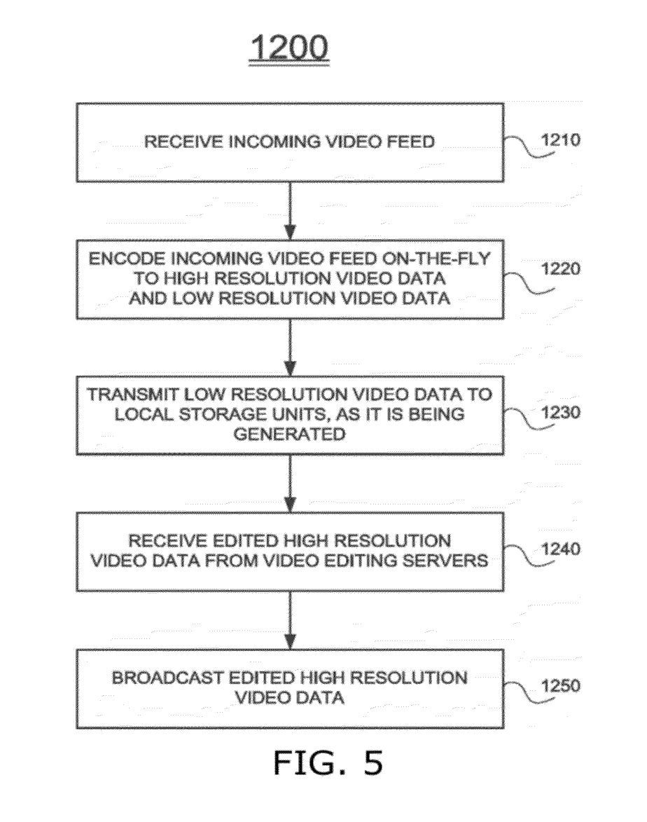

It will further be appreciated from TABLE I that each video format generally specifies inter alia a bit rate, a resolution, an aspect ratio and a television standard. Operation of video server 200 is described with reference to FIGS. 2 and 5.

Each workstation 400 includes a video previewer 410, for previewing a low resolution version of video sample data stored on an LSU 300, and a proxy video editor 420 for generating edit instructions during preview of the low resolution version. The edit instructions are generally in the format of an edit decision list (EDL), generated by placing segments of selected video clips from the low resolution version on a timeline. The edit instructions are applied by a video editor 520 in video editing server 500 to the high resolution video sample data in dedicated storage unit 310 that is ultimately broadcast by video server 200. As such, it will be appreciated by those skilled in the art that the low resolution version of video sample data serves as a proxy for the high resolution version of video sample data that is ultimately edited by video editor 520 in accordance with the edit instructions.

Communication between LSU 300 and video editor 400 generally conforms to an industry standard protocol, such as common Internet file system (CIFS) or network file system (NFS). Video editing server 500 generally has fast access to dedicated storage unit 310.

In accordance with an embodiment of the present invention, one or more high resolution versions of video sample data generated by video encoder 210 are stored on remote storage unit, RSU, 520, for backup purposes.

TABLE I
Sample video formats supported by video encoder 210

| | |
|---|---|
| High | MPEG2-IMX ® PAL 30 Mbps M2V ES 4:3 720 × 608 with 4 PCM stereo |
| Resolution | 1.5 Mbps at 48 Khz 16 bit WAV |
| Production | MPEG2-IMX PAL 30 Mbps M2V ES 16:9 720 × 608 with 4 PCM stereo |
| IMX30 ® | 1.5 Mbps at 48 Khz 16 bit WAV |
| Formats | MPEG2 PAL IMX30 ® 30 Mbps MXF OP1a 4:3 720 × 608 |
| | interleaved with 4 PCM stereo 1.5 Mbps at 48 Khz 16 bit |
| | MPEG2 PAL IMX30 ® 30 Mbps MXF OP1a 16:9 720 × 608 |
| | interleaved with 4 PCM stereo 1.5 Mbps at 48 Khz 16 bit |
| | MOV SC PAL Mpeg2 IMX 30 Mbps 4:3 720 × 608 With 4 |
| | interleaved PCM 48 Khz 16-bit stereo WAV wrapped |
| | MOV SC PAL Mpeg2 IMX 30 Mbps 4:3 720 × 608 With 4 |
| | interleaved PCM 48 Khz 16-bit stereo WAV wrapped |
| High | MPEG2-IMX ® PAL 50 Mbps M2V ES 4:3 720 × 608 with 4 PCM stereo |
| Resolution | 1.5 Mbps at 48 Khz 16 bit WAV |
| Production | MPEG2-IMX ® PAL 50 Mbps M2V ES 16:9 720 × 608 with 4 |
| IMX30 | PCM stereo 1.5 Mbps at 48 Khz 16 bit WAV |
| Formats | MPEG2 PAL IMX50 ® 50 Mbps MXF OP1a 4:3 720 × 608 |
| | interleaved with 4 PCM stereo 1.5 Mbps at 48 Khz 16 bit |
| | MPEG2 PAL IMX50 ® 50 Mbps MXF OP1a 16:9 720 × 608 with |
| | 4 PCM stereo 1.5 Mbps at 48 Khz 16 bit |
| | MOV SC PAL Mpeg2 IMX ® 50 Mbps 4:3 720 × 608 |
| | interleaved with 4 PCM stereo 48 Khz 16-bit |
| | MOV SC PAL Mpeg2 IMX 50 Mbps 16:9 720 × 608 |
| | interleaved with 4 PCM stereo 48 Khz 16-bit |
| High | DVCPRO50 ® PAL 50 Mbps 4:3 720 × 576 DV with 4 PCM |
| Resolution | stereo 1.5 Mbps at 48 Khz 16 bit WAV |
| P2 ® Ingest | DVCPRO50 ® PAL 50 Mbps 16:9 720 × 576 DV with 4 PCM |
| Formats | stereo 1.5 Mbps at 48 Khz 16 bit WAV |
| Proxy | MPEG2 I FRAME PAL ES 4 Mbps 4:3 360 × 288 with 4 Audio |
| Formats | MPEG layer 2 Stereo 256 Kbps at 48 Khz 16 bit MP2 |
| | MPEG2 I FRAME PAL ES 4 Mbps 16:9 360 × 288 with 4 Audio |
| | MPEG layer 2 Stereo 256 Kbps at 48 Khz 16 bit MP2 |
| Streaming | MP4 wrapping H264 PAL 500 Kbps long GOP 4:3 360 × 288 |
| Formats | with 4 interleaved AAC 48 Khz 64 Kbps 16-bit stereo |
| | MP4 wrapping H264 PAL 500 Kbps long GOP 16:9 360 × 288 |
| | with 4 interleaved AAC 48 Khz 64 Kbps 16-bit stereo |

For implementation of system 100, it is convenient to introduce a data structure, referred to herein as a “format set”, defined to be a set of triples of the form

<storage unit>+<video format>+<Boolean: recovery source?>.
Storage unit designates an LSU or an RSU. Recovery source indicates whether the video format is one from which the other formats may be generated. An example of such a format set is as follows.
<main LSU>+<high resolution production format>+<YES>
<backup RSU>+<high resolution production format>+<YES>
<auxiliary LSU>+<low resolution proxy format>+<NO>
<auxiliary LSU>+<low resolution streaming format>+<NO>
Such a format set is used to control video migration within system 100.

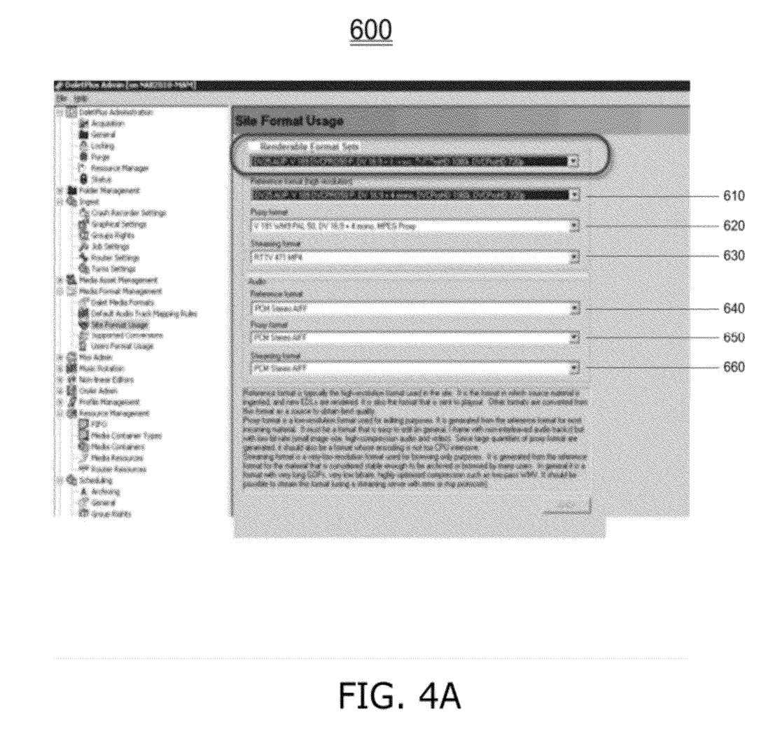

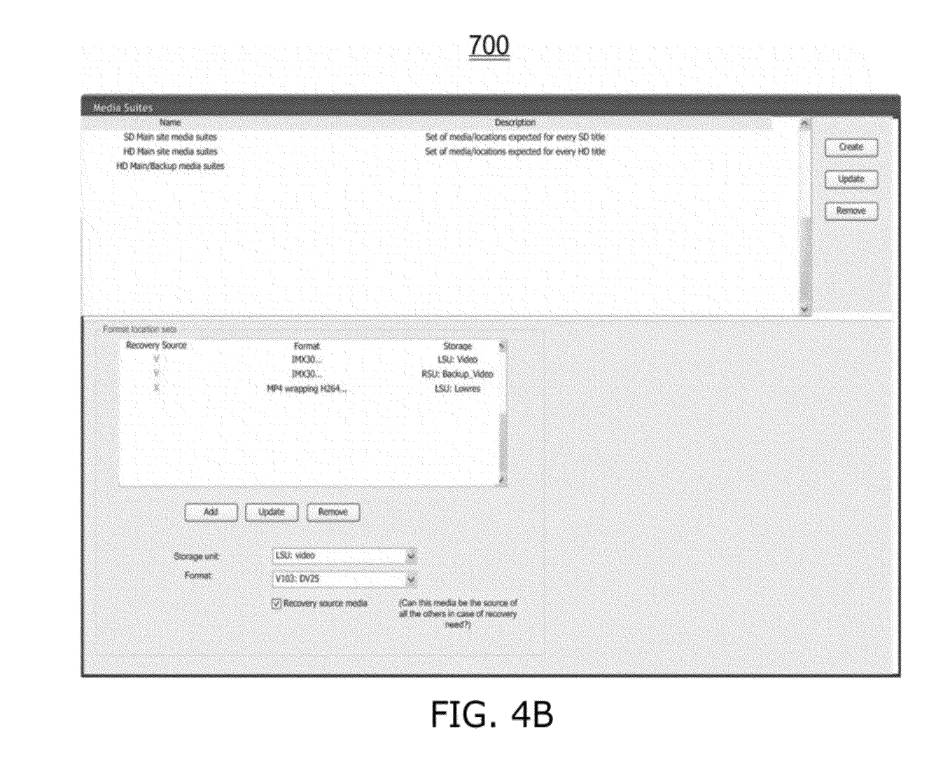

Reference is made to FIGS. 4A and 4B, which are respective screen shots 600 and 700 showing user interfaces for configuring a format set for video ingest, in accordance with an embodiment of the present invention. Shown in FIG. 4A are an entry 610 for designating a high resolution reference video format (“DV25AUP, V 189 DVCPRO50® P,DV 16:9+4 mono, DVCPRO HD® 1080i, DVCPRO HD® 720p”), an entry 620 for designating a low resolution proxy format (“V 191 WM9 PAL 50, DV 16:9+4 mono, MPEG Proxy”), an entry 630 for designating a low resolution streaming format (“RTTV 471 MP4”), an entry 640 for designating a reference audio format (“PCM Stereo AIFF”), an entry 650 for designating a proxy audio format (“PCM Stereo AIFF”), and an entry 660 for designating a streaming audio format (“PCM Stereo AIFF”).

Reference is made to FIG. 5, which is a simplified flow chart for an “ingest-once write-many” workflow 1200 for a media broadcast system, in accordance with an embodiment of the present invention. At operation 1210 a video server, such as video server 200 of FIG. 3, receives an incoming video feed. At operation 1220 the video server encodes the incoming video feed on-the-fly to high and low resolution video sample data. Generally, at operation 1220 at least three versions of video sample data are generated; namely, (i) a high resolution version for production, (ii) a low resolution proxy version for editing, and (iii) a low resolution version for streaming. In addition, (iv) a high resolution version for backup, may also be generated.

At operation 1230 the encoded low resolution versions of the video sample data are transmitted to one or more LSUs, such as LSUs 300 of FIG. 3, as they are being generated. At operation 1240 the video server receives an edited high resolution version of video sample data for production. Finally, at operation 1250 the video server broadcasts the edited high resolution version to a broadcast source, generally for broadcast to television.

In accordance with an embodiment of the present invention, if operation 1230 fails during transmission of one of the versions of the video sample data from the video server to the LSU, then it is re-attempted if the version being transmitted is a recovery source, and is not re-attempted otherwise. In the latter case, the LSU processor subsequently generates the missing version from a recovery source in the LSU.

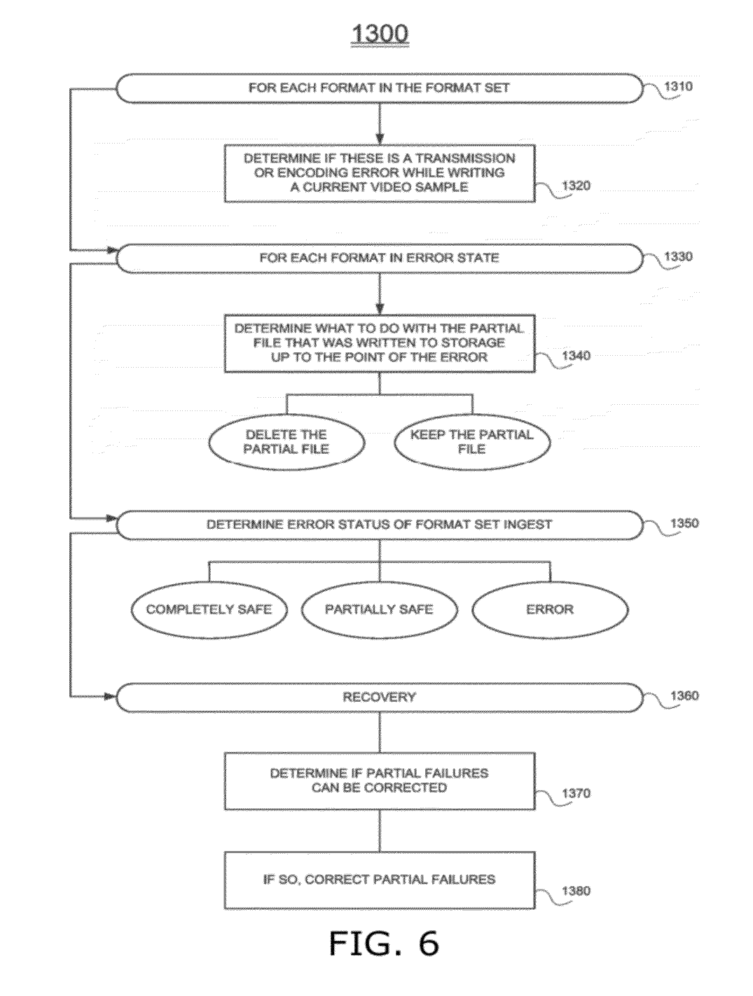

Reference is made to FIG. 6, which is a simplified flow chart for a recovery method 1300 for ingest of a format set, in accordance with an embodiment of the present invention. At operation 1310 each format of the format set is monitored during encoding and transmission, to determine at operation 1320 if there is a transmission or encoding timeout error while writing a current video sample.

At operation 1330 each format that has an error state is analyzed to determine at operation 1340 if the partial file that was written to storage up to the point of the error should be deleted or kept.

At operation 1350 the error status of the format set is determined as being (i) completely safe, i.e., no errors with any target; (ii) partially safe, i.e., errors on same targets, but overall content is recoverable because one recovery version is without errors; or (iii) error; i.e., all recovery versions are in error mode.

At operation 1360, at the end of the ingest job, a recovery is attempted. At operation 1370 a determination is made whether partial failures can be corrected; i.e., whether at least one recovery version is available and completely written to disk. If the determination is affirmative, then at operation 1380 the partial failures are corrected by triggering conversion actions from a recovery version that is available, to the missing target locations.

Aspects of the present invention provide many advantages over conventional broadcast video production systems, including inter alia:
reducing storage bandwidth, by reducing the required number of storage reads;
reducing the required number of servers;
saving time on media operations, since multiple formats and destinations are written at the same time;
simplifying the required architecture; and
improving architecture for disaster recovery, by providing a less costly and more synchronized disaster recovery system.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed is:

1. A video ingest system, comprising:
a video server, comprising:
a receiver for receiving incoming video feeds;
a video encoder for encoding incoming video feeds on-the-fly to one or more versions of high resolution video sample data, and to one or more versions of low resolution video sample data; and
a transmitter for transmitting versions of the low resolution video sample data to respective ones of a plurality of storage units, and for transmitting high resolution video sample data to a broadcaster;
a plurality of storage units, coupled communicatively with said video server; and
a plurality of workstations, coupled communicatively with respective ones of said plurality of storage units, each workstation comprising:
a receiver for receiving a version of the low resolution video sample data from a storage unit;
a video previewer for rendering the version of the low resolution video sample data; and
a proxy video editor for generating edit instructions for the low resolution video sample data that is rendered by said video previewer.

2. The system of claim 1, further comprising a backup storage unit communicatively coupled with said video server and with said plurality of storage units, and wherein said video server transmitter transmits a version of the high resolution video data to said backup storage unit.

3. The system of claim 1 wherein said video server further comprises an administrative console interface for specifying formats of the one or more versions of high resolution video sample data and the one or more versions of low resolution video sample data for said video server encoder to encode, and for specifying the respective storage units to which said video server transmitter transmits the formatted versions.

4. The system of claim 1 wherein at least one of the versions of the low resolution video sample data is formatted as I-frames with non-interlaced audio tracks, and low bit-rate.

5. The system of claim 1 wherein at least one of the versions of the low resolution video sample data is formatted as long MPEG groups of pictures, and low bit-rate.

6. The system of claim 1 wherein at least one of the versions of the low resolution video sample data is formatter as a two-pass Windows Media Video.

7. A method for video ingest, comprising:
receiving, by a video server, an incoming video feed;
encoding, by the video server, the incoming video feed on-the-fly to one or more versions of high resolution video sample data and to one or more versions of low resolution video sample data;
transmitting, by the video server, the versions of the low resolution video sample data to respective ones of a plurality of storage units, as said encoding is being performed; and
further transmitting, by the video server, high resolution video sample data to a broadcaster.

8. The method of claim 7 wherein said encoding conforms to a user-specified set of formats of the one or more versions of high resolution video sample data and the one or more versions of low resolution video sample data.

9. The method of claim 1 wherein said transmitting conforms to a user-specified set of storage units corresponding to the user-specific set of formats.

10. The method of claim 7 further comprising transmitting, by the video server, a version of the high resolution video sample data to a backup storage unit.

11. The method of claim 7 further comprising transmitting, by the video server, a version of the high resolution video sample data to a storage unit dedicated to the video server.

12. The method of claim 7 wherein one or more of the versions of the video sample data are recovery sources, from which the other versions may be generated, and wherein said transmitting further comprises:
when transmission of a version of video sample data fails:
deleting an incomplete version of the video sample data created on the local storage unit;
when the version of the video sample data is a recovery source, re-attempting transmission of the version; and
when the version of the video sample data is not a recovery source, terminating transmission of the version; and
generating each version of video sample data that was not transmitted successfully, from a recovery source.

13. The method of claim 7 wherein at least one of the versions of the low resolution video sample data is formatted as I-frames with non-interlaced audio tracks, and low bit-rate.

14. The method of claim 7 wherein at least one of the versions of the low resolution video sample data is formatted as long MPEG groups of pictures, and low bit-rate.

15. The method of claim 7 wherein at least one of the versions of the low resolution video sample data is formatter as a two-pass Windows Media Video.
